(19) United States
(12) Patent Application Publication
(10) Pub. No.: US 2016/0241469 A1
(43) Pub. Date: Aug. 18, 2016

(54) MULTI-LAYER NETWORK CONTROL METHOD AND DEVICE

(71) Applicant: NEC Corporation, Tokyo (JP)

(72) Inventor: Yohei IIZAWA, Tokyo (JP)

(21) Appl. No.: 15/025,960

(22) PCT Filed: Oct. 20, 2014
(86) PCT No.: PCT/JP2014/005319

§ 371 Date: Mar. 30, 2016

(30) Foreign Application Priority Data
Oct. 21, 2013 (JP) 2013-218495

(51) Int. Cl. H04L 12/715; H04L 12/713; H04L 12/751; H04L 12/709

(52) U.S. Cl. CPC H04L 45/64; H04L 45/245; H04L 45/586; H04L 45/02

(57) ABSTRACT

[Problem] To provide a multi-layer network control method and device whereby it is possible to add a lower layer path in accordance with a path which is requested in an upper layer.

[Solution] With respect to controlling a multi-layer network formed from networks of a plurality of layers, virtual links (L901-L903) are generated in an upper layer network on the basis of topology information of a lower-order network. If at least one virtual link is included in a given path (F701) in the upper layer network, lower layer paths (L601, L602) corresponding to the virtual link are set in the lower layer network.

### TECHNICAL FIELD

The present invention relates to a technology of controlling a multi-layer network.

### BACKGROUND ART

Recent interest in carrier networks has focused on multi-layer structures composed of plurality of layers. For example, a network is conceivable that combines a packet layer, on which network resources can be used efficiently due to a statistical multiplexing effect, with an optical layer, which is suitable for long distance and large capacity transmission. Technologies for a packet layer include, for example, MPLS (Multi-Protocol Label Switching), MPLS-TP (Multi-Protocol Label Switching-Transport Profile), and so on. An optical layer is generally a circuit switching type network, and a typical technology therefor is an OTN (Optical Transport Network). OTNs are further categorized into a TDM (Time Division Multiplexing) layer, a WDM (Wavelength Division Multiplexing) layer, and so on depending on methods of path switching. In such a network, in general, control is applied layer by layer in an independent manner.

On the other hand, considerable attention has been focused on a technology to integrate control of a multi-layer network. That is because automating setting up of a multi-layer network enables a reduction in an operational cost and using resources more efficiently on the basis of information of a plurality of layers enables a reduction in a facility cost. As an example, in PTL 1, a multi-layer path control technology based on an integrated topology design for a network composed of two layers, namely a packet layer and a WDM layer, is disclosed.

### CITATION LIST

### Patent Literature

[PTL 1] JP 2008-211551 A

### SUMMARY OF INVENTION

### Technical Problem

However, in the above-described integration technology of control of a multi-layer network, when a path is searched in an upper layer network, only links for sections to which paths have already been set in a lower layer are taken into account. For example, in the afore-described multi-layer network, paths and links have nested configurations. That is, in the lower layer network, paths are set using nodes, ports, and links in the lower layer as network resources. In the upper layer network, paths that have already been set in the lower layer are treated as links between nodes, the links to which information of nodes and ports is added become network resources in the upper layer, and paths in the upper layer are set using the network resources.

For this reason, for example, even when adding a path in the lower layer enables an upper layer flow path with a lower delay to be obtained, there is no other choice to use only links for sections to which paths have already been set as available network resources in the upper layer. Even when the multi-layer path control method according to PTL 1 is used, it is not possible to set a path in the upper layer taking into account addition of a link to a section that has no link.

Accordingly, an object of the present invention is to provide a multi-layer network control method and device in which, in accordance with a path requested in an upper layer, a path(s) in a lower layer can be added.

### Solution to Problem

A multi-layer network control device according to the present invention is a device to control a multi-layer network composed of a plurality of network layers, and includes a virtual link generation means for generating a virtual link(s) in an upper layer network on the basis of topology information of a lower layer network, and a control means for, when at least one virtual link is included in a given path in the upper layer network, setting up a lower layer path corresponding to the virtual link to the lower layer network.

A multi-layer network control method according to the present invention is a method to control a multi-layer network composed of a plurality of network layers, and includes generating a virtual link(s) in an upper layer network on the basis of topology information of a lower layer network by a virtual link generation means, and setting up a lower layer path corresponding to the virtual link to the lower layer network by a control means, when at least one virtual link is included in a given path in the upper layer network.

### Advantageous Effect of Invention

According to the present invention, adding a path in a lower layer in accordance with a path requested in an upper layer enables a favorable path to be set in an upper layer.

### BRIEF DESCRIPTION OF DRAWINGS

FIG. 1 is a block diagram illustrating a functional configuration of a multi-layer control device according to a first exemplary embodiment of the present invention;

FIG. 2 is a block diagram illustrating a functional configuration of a hierarchy control unit in the multi-layer control device according to the first exemplary embodiment;

FIG. 3 is a configuration diagram illustrating an example of a multi-layer network for a description of an operation of the multi-layer control device according to the first exemplary embodiment;

FIG. 4 is a flowchart illustrating a creation operation of user-facing NWDB (network database) information in the multi-layer control device according to the first exemplary embodiment;

FIG. 5 is a schematic view illustrating a schematic configuration of respective network database information after creation of the user-facing NWDB information illustrated in FIG. 4;

FIG. 6 is a schematic view illustrating an example of a data configuration in the user-facing network database after creation of the user-facing NWDB information illustrated in FIG. 4;

FIG. 7 is a schematic view illustrating an example of a data configuration of an upper layer network database after creation of the user-facing NWDB information illustrated in FIG. 4;

FIG. 8 is a schematic view illustrating an example of a data configuration of a lower layer network database after creation of the user-facing NWDB information illustrated in FIG. 4;

FIG. 9 is a schematic view illustrating an example of layer boundary information that the hierarchy control unit in the multi-layer control device according to the first exemplary embodiment has;

FIG. 10 is a flowchart illustrating an operation of setting up a flow in the multi-layer control device according to the first exemplary embodiment;

FIG. 11 is a schematic view illustrating schematic configurations of the respective network database information after setting up the flow illustrated in FIG. 10;

FIG. 12 is a schematic view illustrating an example of a data configuration of the user-facing network database after setting up the flow illustrated in FIG. 10;

FIG. 13 is a schematic view illustrating an example of a data configuration of the upper layer network database after setting up the flow illustrated in FIG. 10;

FIG. 14 is a schematic view illustrating an example of a data configuration of the lower layer network database after setting up the flow illustrated in FIG. 10;

FIG. 15 is a block diagram illustrating a functional configuration of a multi-layer control device according to a second exemplary embodiment of the present invention;

FIG. 16 is a flowchart illustrating a creation operation of respective user-facing NWDB information in the multi-layer control device according to the second exemplary embodiment; and

FIG. 17 is a flowchart illustrating an operation of setting up a flow in the multi-layer control device according to the second exemplary embodiment.

### DESCRIPTION OF EMBODIMENTS

### Summary of Exemplary Embodiments

According to exemplary embodiments of the present invention, a virtual link(s) in an upper layer network is/are generated on the basis of topology information of a lower layer network in advance, and, when a section(s) to which no path has been set in the lower layer network exist(s) within a flow requested in the upper layer network, setting up a path(s) for the section(s) is performed. As described above, performing setting up a path(s) in the lower layer network in accordance with a request in the upper layer enables a more favorable path, for example, a path with a lower delay, to be set in the upper layer. Hereinafter, simplifying “multi-layer network control” into “multi-layer control” and using a term “flow” as a synonym of a term “path”, exemplary embodiments of the present invention will be described in detail.

### 1. First Exemplary Embodiment

In a first exemplary embodiment of the present invention, a configuration and an operation of a multi-layer control device that controls a multi-layer network composed of two layers will be described in detail.

1.1) Configuration

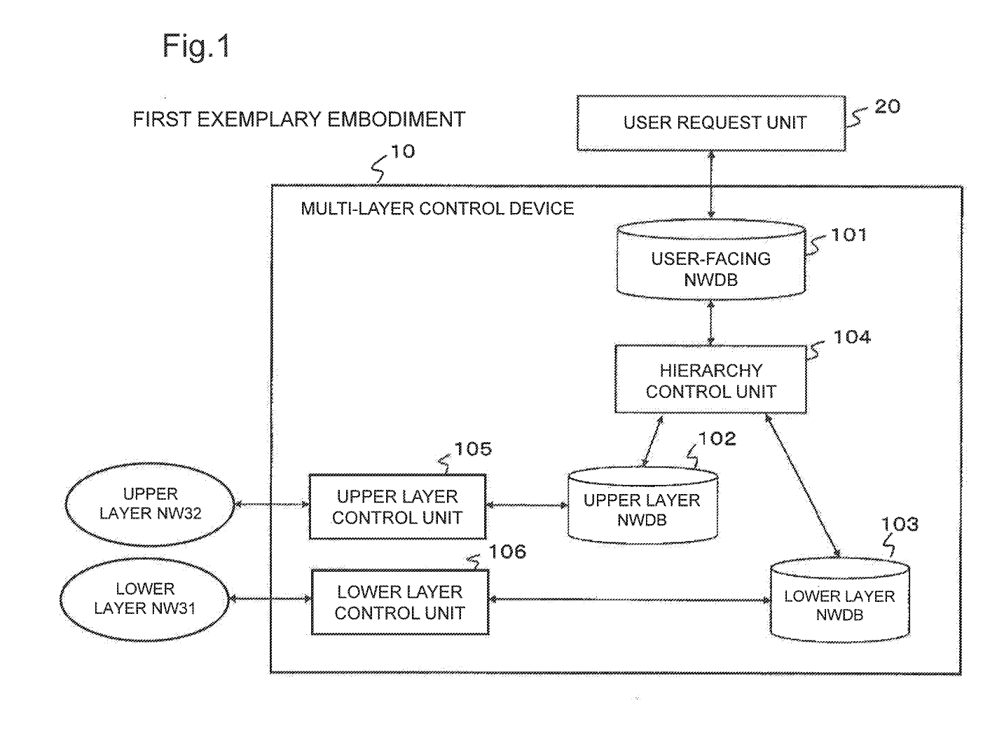

In FIG. 1, a multi-layer control device 10 according to the exemplary embodiment controls a lower layer network 31 and an upper layer network 32 in accordance with a flow request requested by a user through a user request unit 20. The multi-layer control device 10 includes a user-facing NWDB (network database) 101, an upper layer NWDB 102, a lower layer NWDB 103, and a hierarchy control unit 104. The multi-layer control device 10 further includes an upper layer control unit 105 and a lower layer control unit 106 that control the upper layer network 32 and the lower layer network 31 in accordance with respective information changes in the upper layer NWDB 102 and the lower layer NWDB 103, respectively.

The user-facing NWDB 101 is accessed by the user request unit 20 and stores resource information that is available for users. The upper layer NWDB 102 and the lower layer NWDB 103 hold information of the upper layer network 32 and information of the lower layer network 31, respectively. Each network database holds network information that is composed of topology information including information of nodes, ports, and links and flow (equivalent to a path) information set thereto.

The hierarchy control unit 104, as will be described later, performs control, such as conversion to links in the user-facing NWDB 101 and the upper layer NWDB 102, generation of virtual links, registration of the generated virtual links into the user-facing NWDB 101, on the basis of flow information in the lower layer NWDB 103.

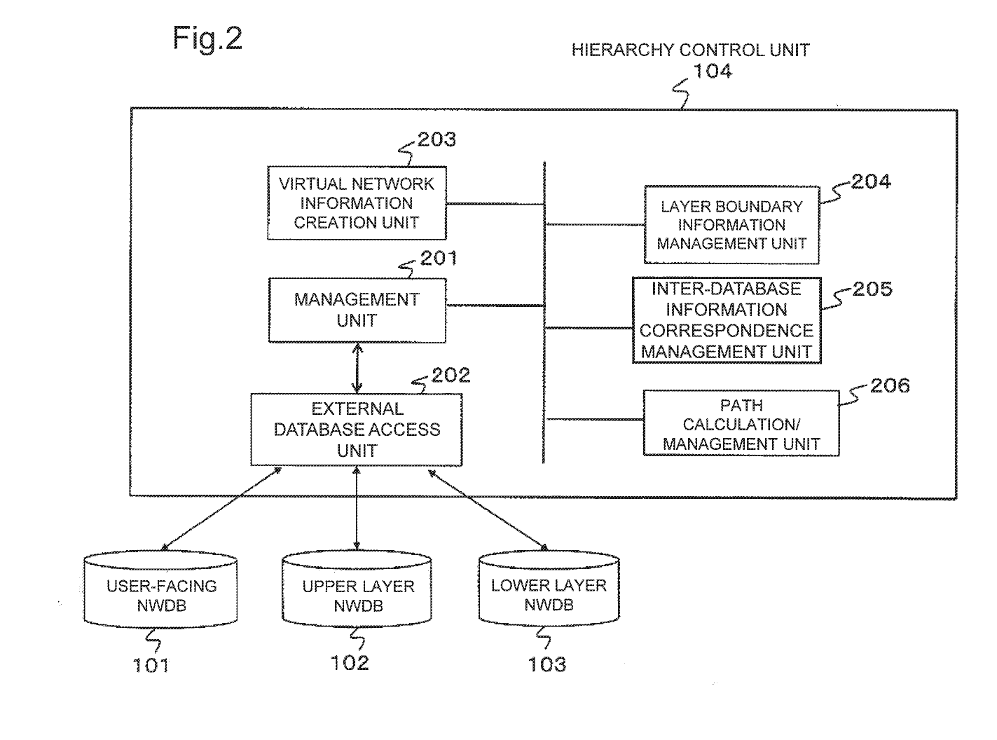

As illustrated in FIG. 2, the hierarchy control unit 104 includes a management unit 201 that performs overall control, access management to external network database, or the like, and performs access to the external network databases 101 to 103 and acquisition or update of information through an external database access unit 202. The hierarchy control unit 104 further includes a virtual network information creation unit 203 that creates virtual link information and virtual port information in the user-facing NWDB 101, a layer boundary information management unit 204 that manages a layer boundary between the upper layer and the lower layer, an inter-database information correspondence management unit 205 that manages correspondences among information stored in the user-facing NWDB 101, the upper layer NWDB 102, and the lower layer NWDB 103, and a path calculation/management unit 206 that performs path calculation and management of calculated paths on the basis of topology information in the network databases.

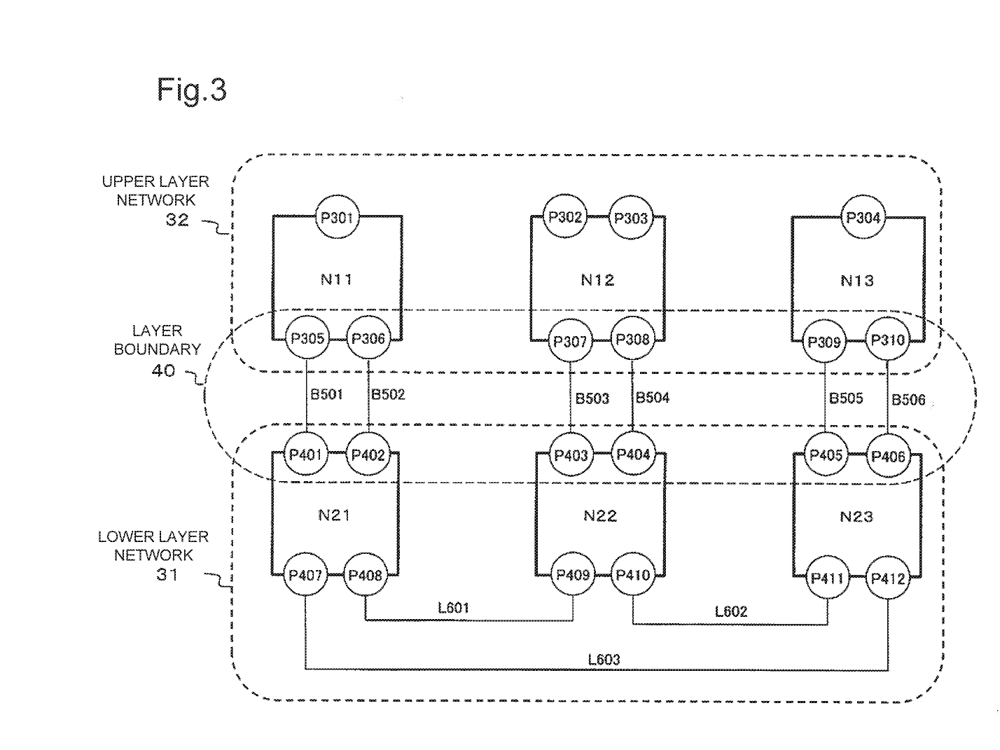

The same functions as those of the hierarchy control unit 104 may be achieved by executing a program stored in a not-illustrated memory in the multi-layer control device 10 on a computer, such as a CPU (Central Processing Unit). Hereinafter, with reference to a multi-layer network exemplified in FIG. 3, an operation of the multi-layer control device 10 according to the exemplary embodiment will be described.

1.2) Configuration Example of Multi-layer Network

As illustrated in FIG. 3, it is assumed that the multi-layer network is composed of the lower layer network 31, the upper layer network 32, and a layer boundary 40. Specifically, the upper layer network 32 includes nodes N11 to N13 and ports P301 to P310, and the lower layer network 31 includes nodes N21 to N23, ports P401 to P412, and links L601 to L603.

Further, it is assumed that the layer boundary 40 is composed of a boundary connection B501 connecting the ports P305 and P401, a boundary connection B502 connecting the ports P306 and P402, a boundary connection B503 connecting the ports P307 and P403, a boundary connection B504 connecting the ports P308 and P404, a boundary connection B505 connecting the ports P309 and P405, and a boundary connection B506 connecting the ports P310 and P406.

It is assumed that the upper layer control unit 105 and the lower layer control unit 106 in the multi-layer control device 10 have acquired information of the upper layer network 32 and the lower layer network 31 in FIG. 3 from the respective networks and registered the information on nodes, ports, and links in the upper layer NWDB 102 and the lower layer NWDB 103, respectively. It is also assumed that information of the layer boundary 40 has been set in the hierarchy control unit 104 in advance.

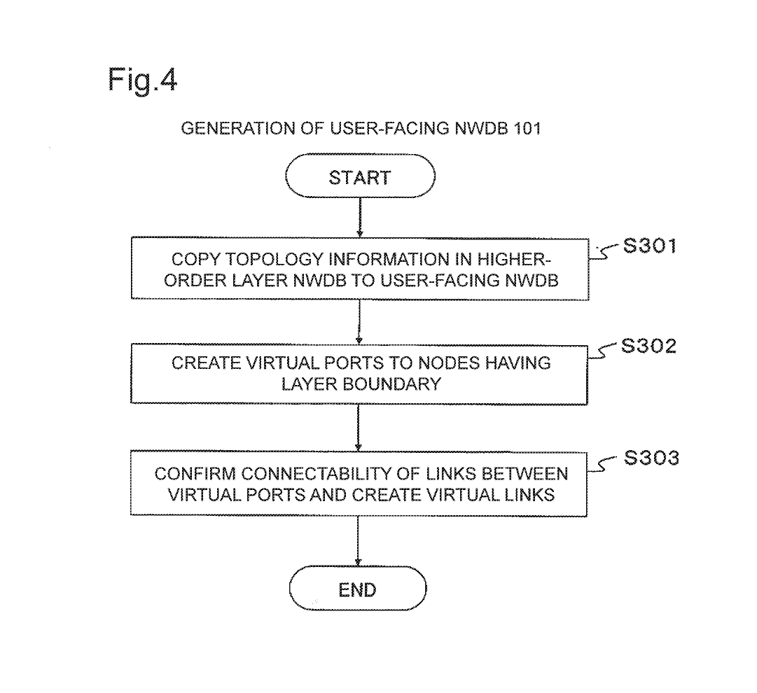

Hereinafter, a creation operation of the user-facing NWDB 101 and an operation of setting up a flow in the multi-layer control device 10 will be described in detail with reference to FIGS. 4 to 14.

1.3) Virtual Link Creation

In FIG. 4, first, the management unit 201 in the hierarchy control unit 104 retrieves topology information of the upper layer from the upper layer NWDB 102 through the external database access unit 202 and copies the retrieved topology information into the user-facing NWDB 101 (action S301). At this time, ports arranged at the layer boundary 40 are not copied.

Subsequently, the virtual network information creation unit 203 in the hierarchy control unit 104 creates virtual ports with respect to nodes in the user NWDB 101 corresponding to nodes having ports at the layer boundary 40 in the upper layer network 32 (action S302). With regard to the number of virtual ports, a sufficient number of virtual ports are created for patterns of virtual links that are to be created. For example, when defining a full-mesh connection among N nodes sharing a layer boundary, (N−1) virtual ports are created for each node.

Subsequently, the virtual network information creation unit 203 performs confirmation of connectability with respect to links connecting created virtual ports to each other and creation of virtual links (action S303). For example, when defining a full-mesh connection among nodes sharing a layer boundary, confirmation of connectability is performed with respect to all pairs of nodes to be connected and, thereafter, virtual links are created. Specifically, the confirmation of connectability is to perform path calculation for between lower layer nodes using the path calculation/management unit 206 and, if a path is found, decide that there is a possibility of connection.

For example, in the confirmation of connectability between the nodes N11 and N12 in FIG. 3, path calculation for between the lower layer nodes N21 and N22 at the layer boundary 40 is performed. In the example in FIG. 3, since a path going through the link L601 exists between the nodes N21 and N22, it is decided that there is a possibility of connection between the nodes N21 and N22. When there is a possibility of connection, the virtual network information creation unit 203 creates a virtual link connecting a virtual port of the node N11 and a virtual port of the node N12 in the user-facing NWDB 101.

In so doing, the hierarchy control unit 104 holds the calculated path information and a list of links between the nodes N21 and N22 (in this case, only the link L601) in association with the virtual link. When the path calculation fails, no virtual link is created. In such a case, virtual ports of the nodes at both ends may be deleted. Performing the above-described operation with respect to all pairs of nodes sharing the layer boundary 40 in the user-facing NWDB 101 enables virtual links connecting the nodes in a full-mesh manner to be created.

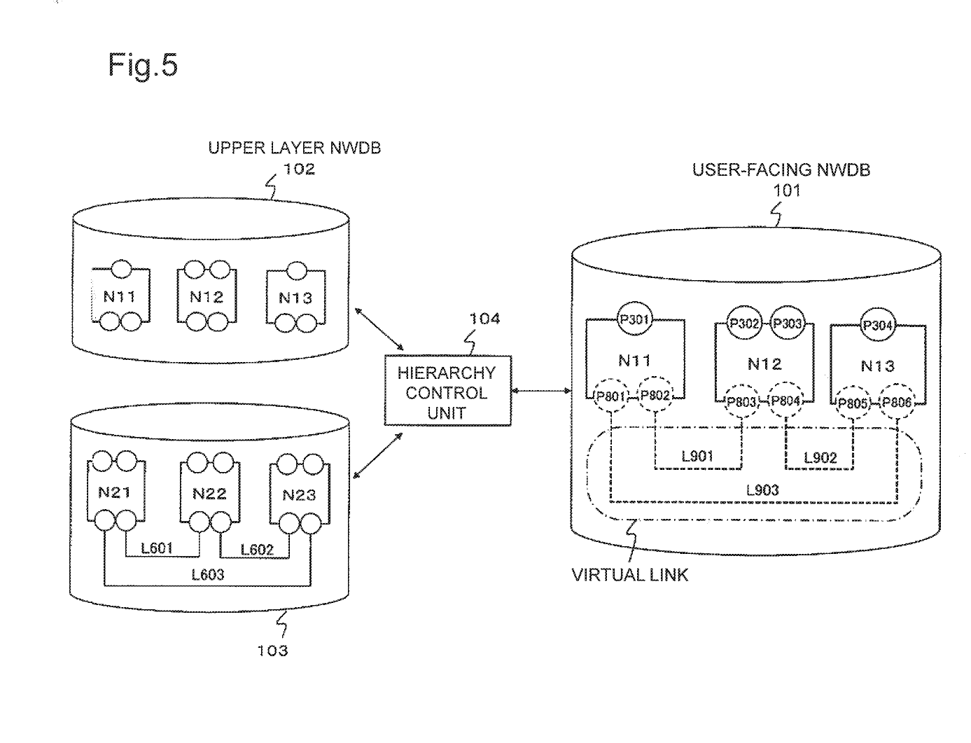

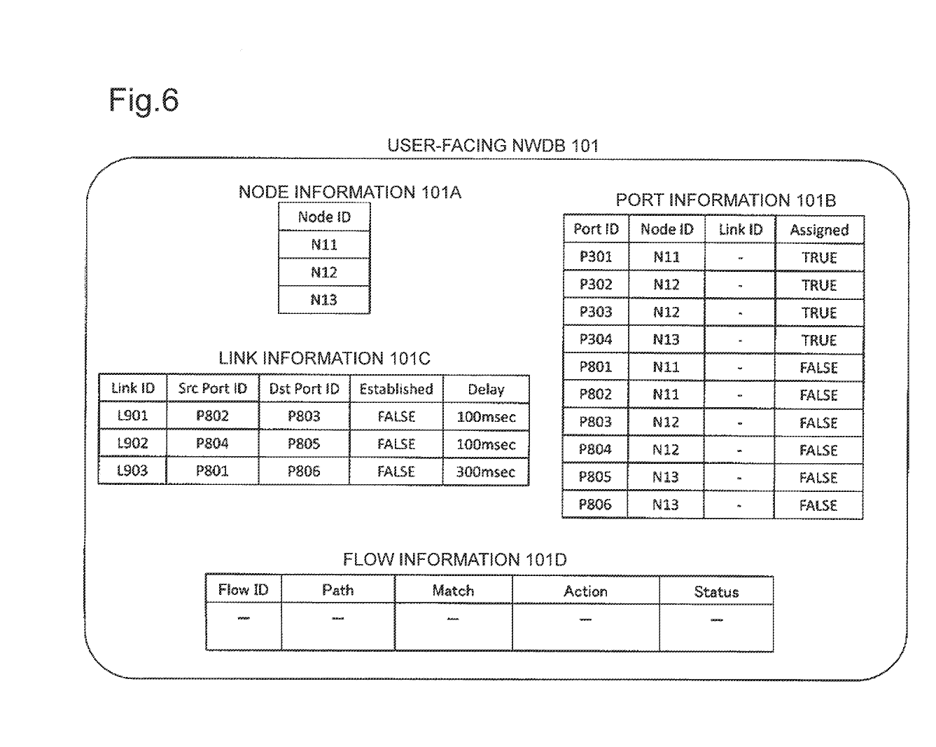

As a result, the hierarchy control unit 104 stores information on the nodes in the upper layer and information on virtual links by which the nodes are connectable into the user-facing NWDB 101, as illustrated in FIG. 5. In this case, the nodes N11 to N13, virtual ports P801 to P806, which are illustrated by dotted circles, of the respective nodes, and virtual links L901 to L903, which are illustrated by dotted lines, are stored in the user-facing NWDB 101. FIG. 6 illustrates a specific data configuration of the user-facing NWDB 101 in the multi-layer network in FIG. 3.

As illustrated in FIG. 6, topology information including node information 101A, port information 101B, and link information 101C is registered in the user-facing NWDB 101. The node information 101A indicates identification information of the respective nodes. Each entry in an “Assigned” attribute of the port information 101B is information that indicates whether or not the port corresponding thereto is a virtual port, and indicates that, in the case of TRUE, the port is a real port instead of a virtual port and, in the case of FALSE, the port is a virtual port. Each entry in an “Established” attribute of the link information 101C is information that indicates whether or not the link corresponding thereto is a virtual link, and indicates that, in the case of TRUE, the link is an already set link based on which a flow has actually been set in the lower layer network and, in the case of FALSE, the link is a virtual link. To a delay of each link (in a Delay attribute), the total sum of link delays on a path that the hierarchy control unit 104 has calculated in creating each virtual link is registered as metric information. That is, each delay (in the Delay attribute) represents a link delay that is caused when a link is created by setting up a lower layer flow for the corresponding section.

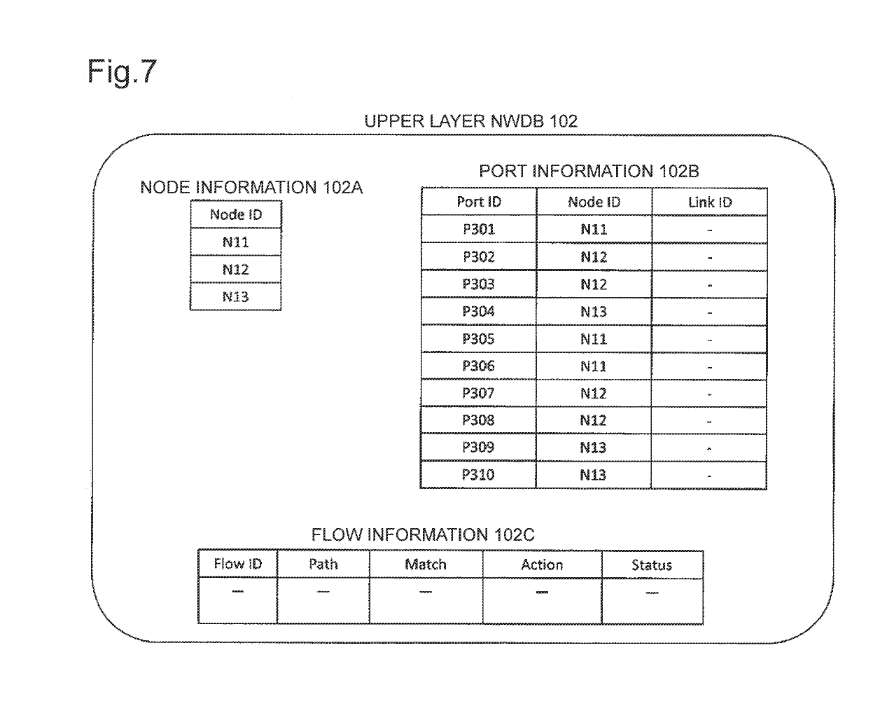

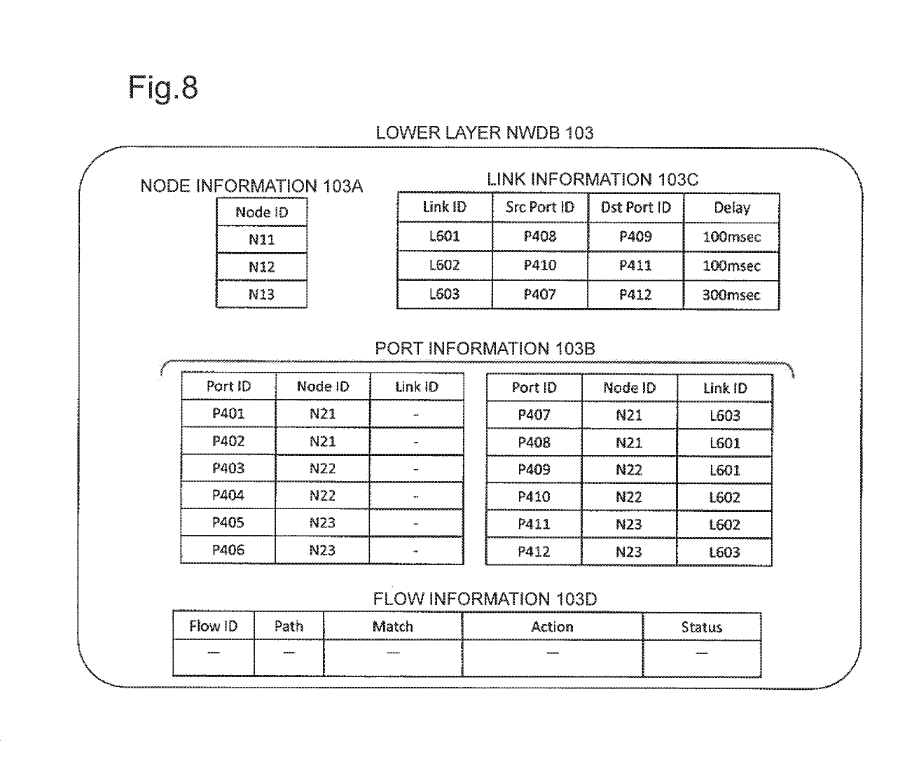

FIGS. 7 and 8 illustrate the upper layer NWDB 102 and the lower layer NWDB 103 in creating the user-facing NWDB 101, respectively. Since no flow has been set in the lower layer network, the upper layer NWDB 102 illustrated in FIG. 7 has no link information and has only node information 102A and port information 102B registered. However, depending on a configuration of the network, a link(s) connecting ports both of which are not placed at the layer boundary is/are registered in some cases. In this case, information including such a link(s) is copied to the user-facing NWDB.

In the lower layer NWDB 103 illustrated in FIG. 8, topology information including node information 103A, port information 103B, and link information 103C has been registered. Each delay information (in a Delay attribute) in the link information 103C is, for example, a propagation delay based on the physical distance of the corresponding link, and is registered by the lower layer control unit 106. While no flow is registered in the lower layer NWDB 103, a flow(s) has/have been registered in some cases depending on an initial condition of the network. In this case, an already set link(s) corresponding to the respective flow(s) is/are created first, and, thereafter, an operation to create a virtual link(s) is performed.

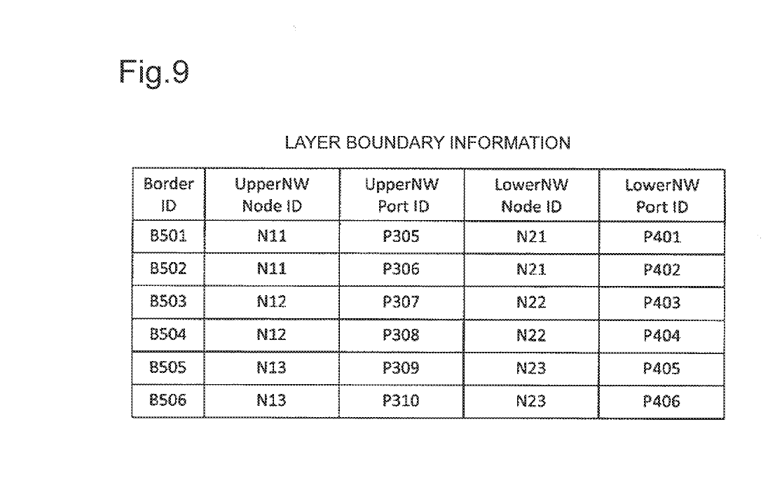

FIG. 9 illustrates a data configuration of the layer boundary 40 that the layer boundary information management unit 204 in the hierarchy control unit 104 holds.

Information of nodes, ports, links, and flows in the respective network databases is not limited to the above-described information. For example, information on a maximum bandwidth, a remaining bandwidth, and a bandwidth set aside for a flow may be added to each port, and cost information for path calculation may be added as metric information in addition to link delays. For example, when a network that is subject to control is an optical layer network, available resource information and unused resource information may be added to the ports. The resource information corresponds to wavelengths in the case of a WDM layer and time slots in the case of a TDM layer.

1.4) Operation of Setting Up a Flow

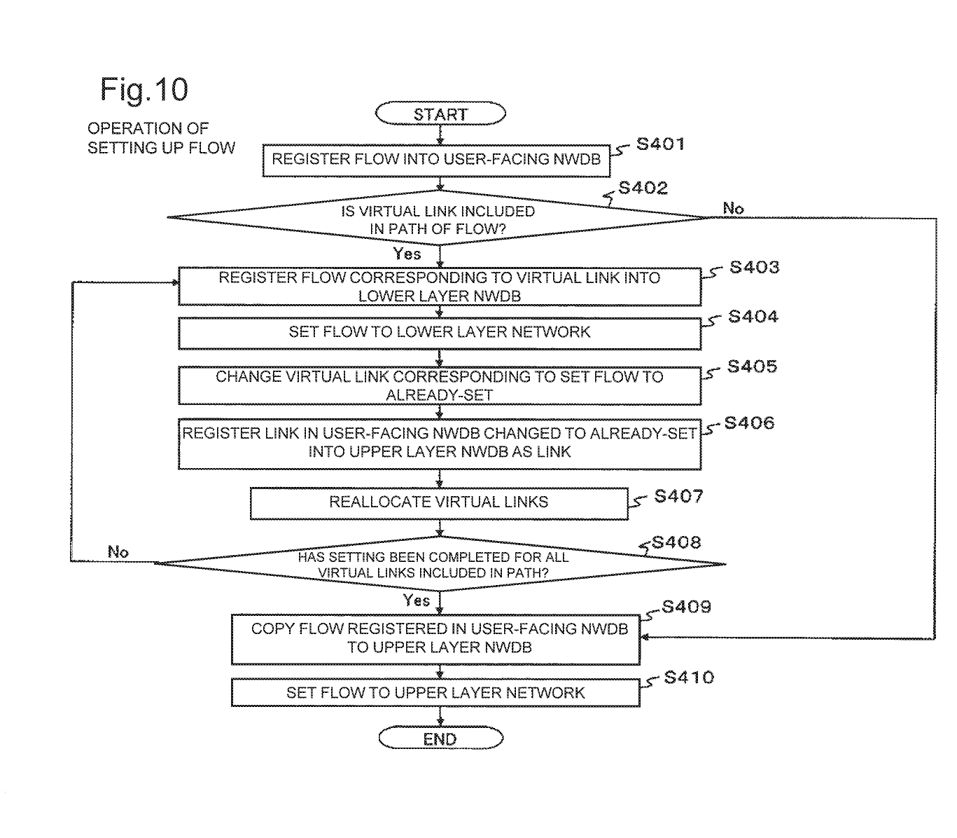

Next, an operation of the multi-layer control device 10 when a flow is added to the user-facing NWDB 101 will be described with reference to FIGS. 10 to 14.

First, on the basis of a requirement of a flow that is to be set, the user request unit 20 performs path calculation for the flow referring to the topology information in the user-facing NWDB 101 exemplified in FIG. 6. In this example, it is assumed that, as a flow requirement, a flow from the port P301 of the node N11 to the port P304 of the node N13 (refer to FIG. 5) with a minimum delay is requested. As illustrated in FIG. 5, path candidates for a flow from the node N11 to the node N13 include a first path (with a total delay of 200 msec) that passes through the link L901 (with a delay of 100 msec) and the L902 (with a delay of 100 msec) and a second path (with a total delay of 300 msec) that passes through the link L903 (with a delay of 300 msec). In this case, since the first path has a smaller delay, the user request unit 20 selects the first path (L901-L902). As an algorithm to calculate a path with a minimum delay, for example, Dijkstra's algorithm in which delays are considered costs of links may be used.

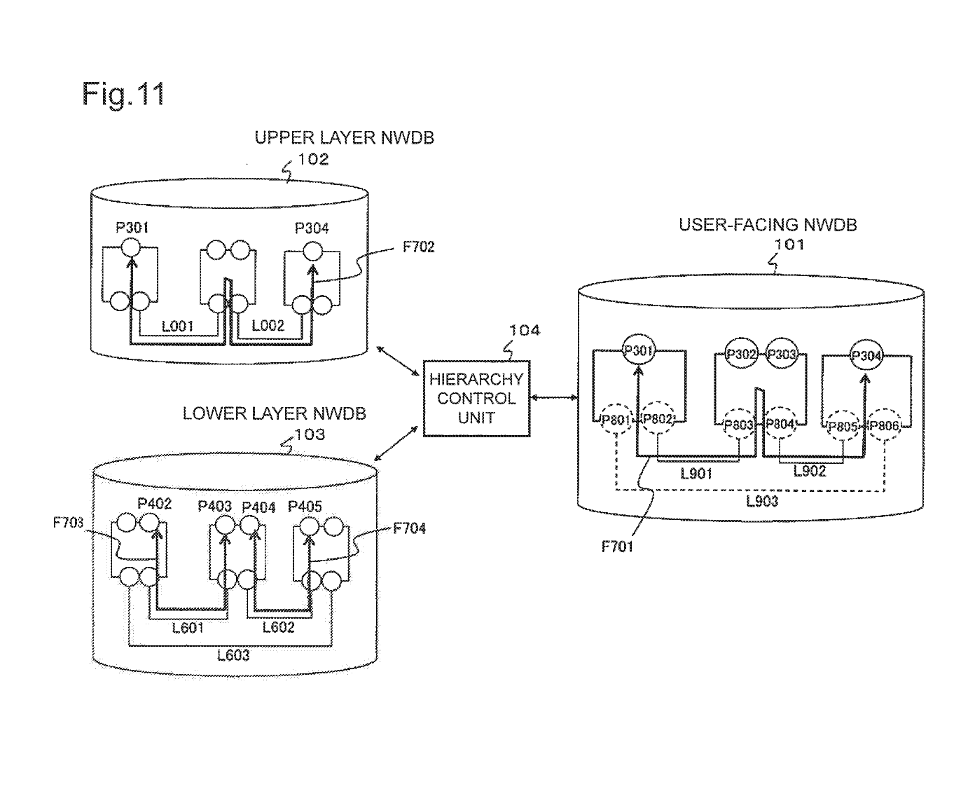

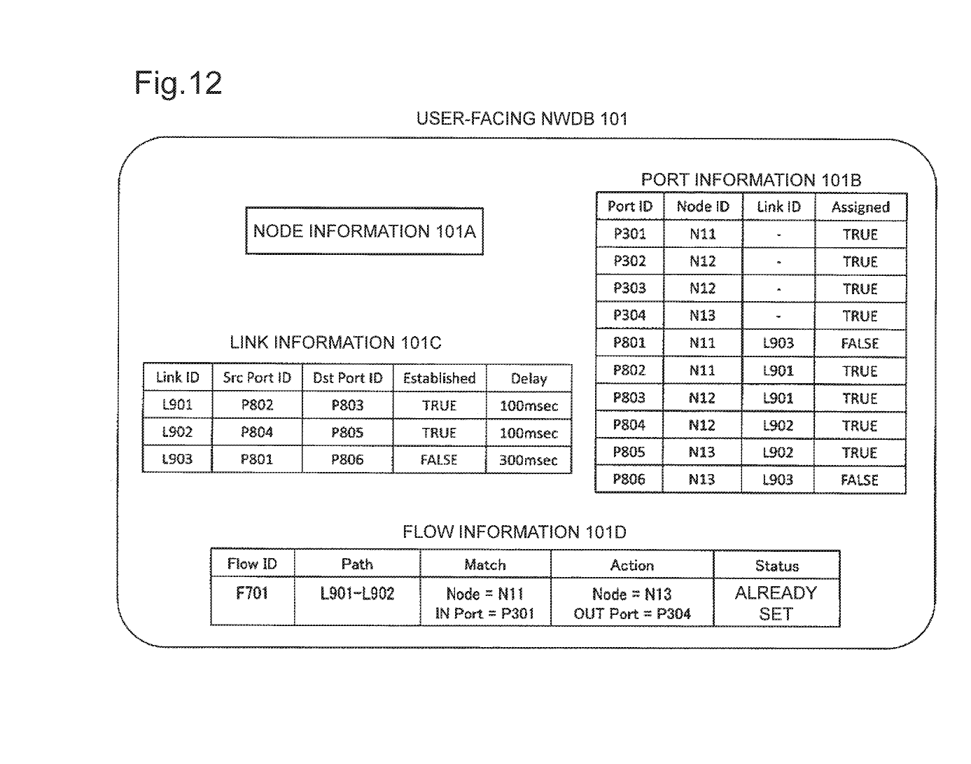

In FIG. 10, the user request unit 20 registers a flow F701 having the selected first path (L901-L902) in the user-facing NWDB 101 (action S401). The flow F701 in the user-facing NWDB 101 is illustrated schematically in FIG. 11. At this time, a Status attribute of flow information 101D in the user-facing NWDB 101 illustrated in FIG. 12 is set to a status “under setting”.

When the flow F701 is registered into the user-facing NWDB 101 by the user request unit 20, the hierarchy control unit 104 confirms whether or not a virtual link(s) is/are included in the path of the flow F701 (action S402). In this example, two virtual links, namely the virtual links L901 and L902, are included in the flow F701.

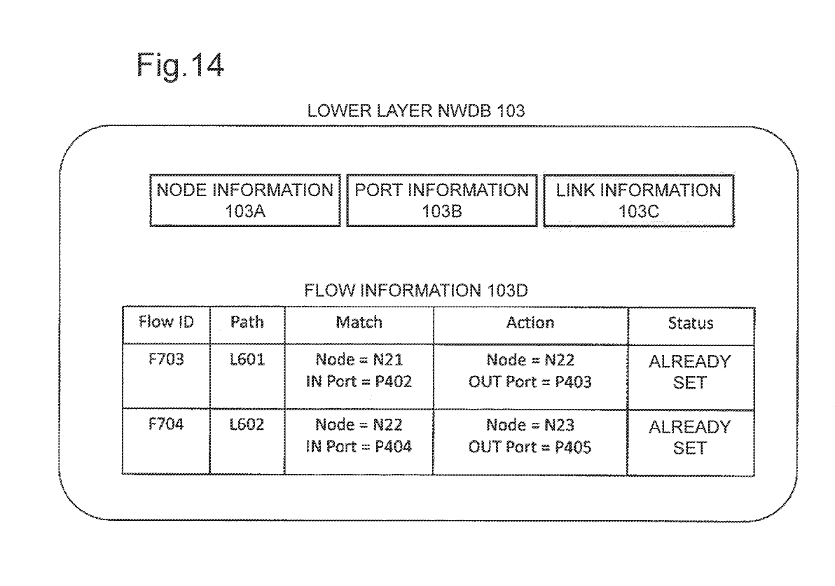

If a virtual link(s) is/are included (Yes in action S402), the hierarchy control unit 104 first registers a flow corresponding to a virtual link (in this case, L901) into the lower layer NWDB 103 (action S403). Specifically, referring to FIG. 11, the path in the lower layer corresponding to the virtual link L901 is a path passing through the link L601 between the nodes N21 and N22, and it is thus assumed that, as the endpoints of the flow, the port P402 of the node N21 and the port P403 of the node N22 included in the layer boundary 40 are selected. Thus, as illustrated in FIG. 14, the hierarchy control unit 104 registers a flow F703 that has the link L601 as the path thereof and the ports P402 and P403 as the endpoints thereof in the lower layer NWDB 103. However, a Status attribute of the flow F703 is set to the status “under setting” at this time.

When the flow F703 is registered in the lower layer NWDB 103, the lower layer control unit 106 actually sets the flow to respective network devices in the lower layer network 31 in accordance with the information of the registered flow F703 (action S404). When setting up of the flow is completed, the lower layer control unit 106 changes the Status attribute of the flow F703 in the lower layer NWDB 103 to a status “already set”, as illustrated in FIG. 14.

When setting up of the flow by the lower layer control unit 106 is completed, the hierarchy control unit 104 changes the status of the virtual link in the user-facing NWDB 101 corresponding to the flow F703 that has been set to the status “already set” (action S405). Specifically, as illustrated in FIG. 12, the Established (already set) attribute of the virtual link L901 is changed to “TRUE”. Association of the endpoints of the virtual link L901, that is, the virtual ports P802 and P803, with ports in the upper layer NWDB 102 is performed at the same time. Since the endpoint ports of the flow F703 in the lower layer NWDB 103 are the port P402 of the node N21 and the port P403 of the node N22, referring to the layer boundary information illustrated in FIG. 9 reveals that ports in the upper layer network 32 corresponding to the ports P402 and P403 are P306 and P307, respectively. Thus, the inter-database information correspondence management unit 205 of the hierarchy control unit 104 associates the port P306 of the node N11 and the port P307 of the node N12 in the upper layer NWDB 102 with the virtual port P802 and the virtual port P803 in the user-facing NWDB 101, respectively, and holds the port correspondence relations. As illustrated in FIG. 12, the management unit of the hierarchy control unit 104 changes both the Assigned attributes of the virtual ports P802 and P803 in the port information 101B in the user-facing NWDB 103 to “TRUE”.

Subsequently, the hierarchy control unit 104 registers the link in the user-facing NWDB 101 that was/were changed to the already set status in the last action into the upper layer NWDB 102 as a link (action S406). Specifically, on the basis of inter-database information correspondences that have been held, a link L001 corresponding to the link L901 in the user-facing NWDB 101 is registered as a link between the ports P306 and P307 in the upper layer NWDB 102. In so doing, other information of the link, such as delays, is also copied. The inter-database information correspondence management unit 205 also holds a correspondence relation between the link L901 in the user-facing NWDB 101 and the link L001 in the upper layer NWDB 102 as an inter-database information correspondence.

When the link registration to the upper layer NWDB 102 is completed, the hierarchy control unit 104 performs reallocation of virtual links (action S407). Specifically, among the nodes in the upper layer network 32, a node to all the ports of which at the layer boundary links have been set by the link and setting up of the flow hitherto performed is excluded from virtual port creation target nodes in the user-facing NWDB 101. The virtual ports and the virtual links of the node excluded by the above processing are also removed from the user-facing NWDB 101. Conversely, if a node(s) exist(s) that, in spite of having a port(s) at the layer boundary to which no link is set in the upper layer, has/have no virtual port set in the user-facing NWDB 101, virtual ports and virtual links are added. For example, when virtual links have been created in a full-mesh manner, virtual ports are added to all the virtual port creation target nodes including such a node(s), and, by the same action as action S303 in FIG. 4, virtual links are created. If a virtual link(s) that the flow registered in the user-facing NWDB 101 passes through is/are removed by the virtual link reallocation, setting up of the flow becomes a failure, and, thus, the Status information of the flow is changed to “setting failed”. In this case, for example, the user request unit 20 resets the flow to another path using the topology information in the user-facing NWDB 101.

The hierarchy control unit 104 performs the above-described actions S403 to S407 for all the virtual links that the flow that has been initially registered in the user-facing NWDB 101 passes through (action S408). As described above, although the processing for the virtual link L901 has been completed out of two virtual links L901 and L902 included in the flow F701, the other virtual link L902 is left unprocessed (No in action S408). Thus, the above-described actions S403 to S407 are performed for the virtual link L902.

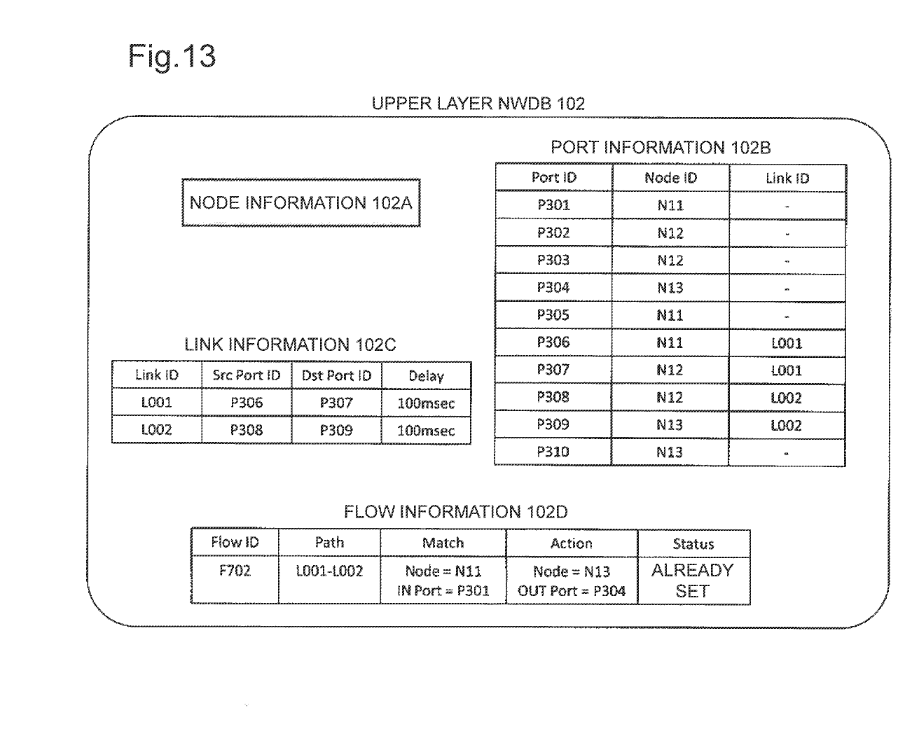

When setting up of the path for all the virtual links has been completed (Yes in action S408) or no virtual link is included in the path of the flow F701 (No in action S402), the hierarchy control unit 104 copies the information of the flow registered in the user-facing NWDB 101 to the upper layer NWDB 102 (action S409). In the example, while the information of the flow F701 in the user-facing NWDB 101 is copied and registered into flow information 102D in the upper layer NWDB 102 as a flow F702, a Status attribute of the flow F702 illustrated in FIG. 13 is set to “under setting”.

When the flow is registered in the upper layer NWDB 102, the upper layer control unit 105 actually sets up the flow to the respective network devices in the upper layer network 32 in accordance with the registered information of the flow F702 (action S410). When the setting up is completed, the upper layer control unit 105 changes the Status information of the flow F702 in the upper layer NWDB 102 to “already set”, as illustrated in FIG. 13. When the hierarchy control unit 104 detects the change, the hierarchy control unit 104 changes the Status attribute of the flow F701 in the user-facing NWDB 101 to “already set”, as illustrated in FIG. 12. The change in the flow information in the user-facing NWDB 101 enables the user request unit 20 to notice the completion of setting up of the flow.

With the above-described actions, the hierarchy control unit 104 sets required flows to the lower layer network 31 and the upper layer network 32, as illustrated in FIG. 11. As described above, the data configurations of the user-facing NWDB 101, the upper layer NWDB 102, and the lower layer NWDB 103 illustrated in FIG. 11 are exemplified in FIGS. 12, 13, and 14, respectively.

In the user-facing NWDB 101 illustrated in FIG. 12, the flow information 101D has been added in addition to the topology information (101A, 101B, and 101C). The Established information of the links the status of which have been changed to the already set status has been set to “TRUE”, and the Assigned information of the ports that have been associated with ports in the upper layer network has been set to “TRUE”. As described above, when a flow is added to the user-facing NWDB 101, the multi-layer control device 10 performs required setting up to each of the lower layer network 31 and the upper layer network 32.

In the upper layer NWDB 102 illustrated in FIG. 13, the links L001 and L002 have been added because flows have been set in the lower layer network 31. Information of a set flow has also been added.

In the lower layer NWDB 103 illustrated in FIG. 14, flow information 103D has been added in addition to the topology information (103A, 103B, and 103C). Path information is held in a Path attribute in a form of a list of links that flows go through. Information of the node and port of the input side endpoint of a flow and information of the node and port of the output side endpoint of the flow are held in a Match attribute and an Action attribute, respectively.

1.5) Advantageous Effect

As described above, according to the first exemplary embodiment of the present invention, virtual links are created in the user-facing NWDB 101, and estimate information, such as a delay when a flow is set in the lower layer, is stored together with each virtual link. With this processing, even in a state in which no flow has been set in the lower layer yet and there is no link set in the upper layer, users are able to determine a path that satisfies a requirement of a flow that is to be set to perform setting up the path, while taking into account addition of links. That is, it is possible to perform setting up the path taking into account addition of a link(s) for a section(s) to which no link is set in the lower layer network 31.

### 2. Second Exemplary Embodiment

A multi-layer control device according to a second exemplary embodiment of the present invention controls a network having three layers. The three layers are individually referred to as a first layer, a second layer, and a third layer in ascending order from the lower layer.

2.1) Configuration

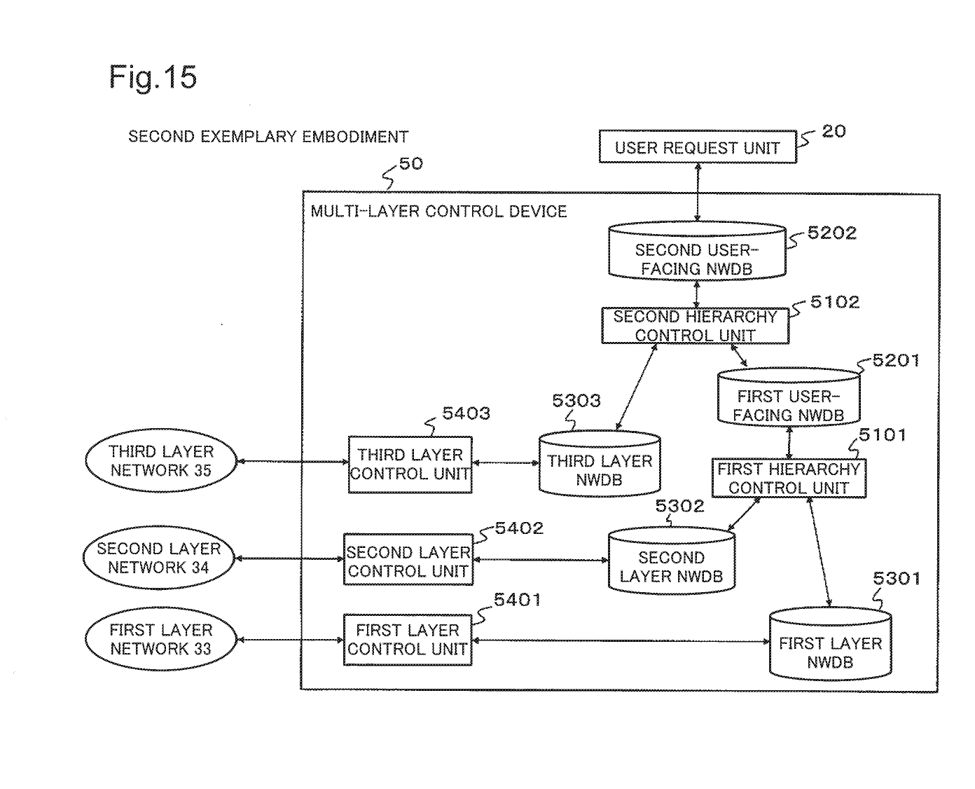

In FIG. 15, a multi-layer control device 50 according to the exemplary embodiment controls a first layer network 33, a second layer network 34, and a third layer network 35 in accordance with a flow request requested by a user through a user request unit 20. The multi-layer control device 50 includes first and second hierarchy control units 5101 and 5102, first and second user-facing NWDBs 5201 and 5202, first, second, and third layer NWDBs 5301 to 5303, and first, second, and third layer control units 5401 to 5403.

The first user-facing NWDB 5201 is a user-facing NWDB for the first hierarchy control unit 5101 and a lower layer NWDB for the second hierarchy control unit 5102. The second user-facing NWDB 5202 is a user-facing NWDB for the second hierarchy control unit 5102.

The first layer NWDB 5301 is a lower layer NWDB for the first hierarchy control unit 5101 and holds network information of the first layer network 33. The second layer NWDB 5302 is an upper layer NWDB for the first hierarchy control unit 5101 and holds network information of the second layer network 33. The third layer NWDB 5303 is an upper layer NWDB for the second hierarchy control unit 5102 and holds network information of the third layer network 33.

The first, second, and third layer control units 5401 to 5403 control the first, second, and third layer networks 33 to 35 in accordance with changes in respective information in the first, second, and third layer NWDBs 5301 to 5303, respectively.

2.2) Creation of User-facing NWDB

As a precondition, it is assumed that the first layer control unit 5401, the second layer control unit 5402, and the third layer control unit 5403 in the multi-layer control device 50 have acquired, from the first, second, and third layer networks 33 to 35, respective network information thereof and registered information of nodes, ports, and links into the first, second, and third layer NWDBs 5301 to 5303, respectively. It is also assumed that layer boundary information between the first layer and the first layer and layer boundary information between the second layer and the third layer have been set to the first hierarchy control unit 5101 and the second hierarchy control unit 5102, respectively.

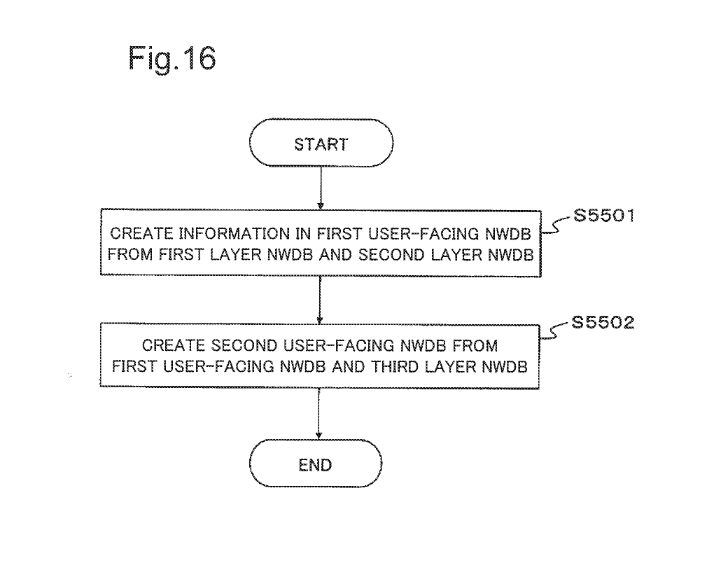

In FIG. 16, the first hierarchy control unit 5101, treating the first layer NWDB 5301 and the second layer NWDB 5302 as a lower layer NWDB and an upper layer NWDB, respectively, creates information in the first user-facing NWDB 5201 (action S5501). Specific creation actions are the same as the actions in the first exemplary embodiment illustrated in FIG. 4.

Next, the second hierarchy control unit 5102, treating the first user-facing NWDB 5201 and the third layer NWDB 5303 as a lower layer NWDB and an upper layer NWDB, respectively, creates information in the second user-facing NWDB 5202 (action S5502). Specific creation actions are the same as the actions in the first exemplary embodiment illustrated in FIG. 4. With the above actions, the creation of information in the first and second user-facing NWDBs 5201 and 5202 is completed.

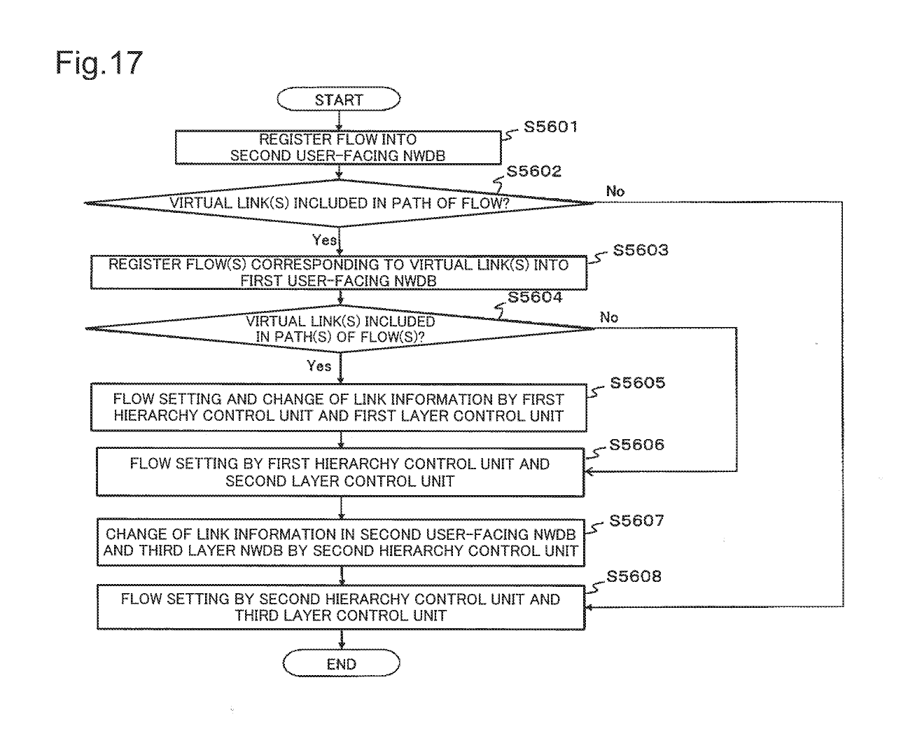

2.3) Operation of setting up a flow Next, with reference to FIG. 17, a multi-layer control operation according to the second exemplary embodiment when a flow is added to the second user-facing NWDB 5202 will be described.

Referring to topology information in the second user-facing NWDB 5202, the user request unit 20, on the basis of a requirement of the flow that is to be set, performs path calculation for the flow and registers the flow into the second user-facing NWDB 5202 (action S5601). A specific action in the above processing is the same as action S401 in FIG. 10.

When the flow is registered in the second user-facing NWDB 5202 by the user request unit 20, the second hierarchy control unit 5102 confirms whether or not a virtual link(s) is/are included in the path of the registered flow (action S5602). When a virtual link(s) is/are included (Yes in action S5602), the second hierarchy control unit 5102 registers a flow(s) corresponding to the virtual link(s) into the first user-facing NWDB 5201, which is equivalent to a lower layer NWDB when viewed from the second hierarchy control unit 5102 itself (action S5603). A specific action in the above processing is the same as action S401 in FIG. 10.

When the flow(s) is/are registered into the first user-facing NWDB 5201, the first hierarchy control unit 5101 confirms whether or not a virtual link(s) is/are included in the path(s) of the registered flow(s) (action S5604). When a virtual link(s) is/are included (Yes in action S5604), registration of flow(s) into the first layer NWDB 5301 by the first hierarchy control unit 5101, setting up of the flow(s) by the first layer control unit 5401, and change of the link information in the first user-facing NWDB 5201 and change of the link information in the second layer NWDB 5302 by the first hierarchy control unit 5101 are performed (action S5605). Specific actions in the above processing are the same as the actions in the first exemplary embodiment, namely action S403 to S408 (Yes) in FIG. 10.

After action S5605 is completed or when no virtual link is included (No in action S5604), with respect to the flow(s) registered in the first user-facing NWDB 5201, copying of the information of the flow(s) to the second layer NWDB 5302 by the first hierarchy control unit 5101 and setting up of the flow(s) to the second layer network 34 by the second layer control unit 5402 are performed (action S5606). Specific actions in the above processing are the same as the actions in the first exemplary embodiment, namely actions S409 to S410 in FIG. 10.

Since performing action S5606 has completed setting up the flow to the first user-facing NWDB 5201, which is a lower layer NWDB for the second hierarchy control unit 5102, the second hierarchy control unit 5102 performs change of the virtual link(s) in the second user-facing NWDB 5202 to a link(s) with a status “already set” and registration of the information of the link(s) into the third layer NWDB 5303 (action S5607). Specific actions in the above processing are the same as the actions in the first exemplary embodiment, namely actions S405 to S407 in FIG. 10.

After action S5607 is completed or when no virtual link is included in the path of the registered flow (No in action S5602), the second hierarchy control unit 5102 registers the flow registered in action S5601 into the third layer NWDB 5303, and the third layer control unit 5403 sets the flow to the third layer network 35 (action S5608).

In such a manner, when a flow is added to the second user-facing NWDB 5202, the multi-layer control device 50 performs required setting up to the first layer, second layer, and third layer networks 33 to 35 individually.

Although, in the exemplary embodiment, an example of a multi-layer network composed of three layers was described, the multi-layer control device including [(the number of layers)−1] hierarchy control units enables a multi-layer network composed of three or more layers to be controlled in a similar manner.

As described above, combining two or more internal configurations of multi-layer control devices of the first exemplary embodiment, as exemplified in FIG. 15, makes it possible to apply the present invention to control of a network having three or more layers.

### 3. Supplementary Notes

All or part of the exemplary embodiments described above may be described as in the following supplementary notes, but the present invention is not limited thereto.

### Supplementary Note 1

A multi-layer network control device that is a device to control a multi-layer network composed of a plurality of network layers, including:

a virtual link generation means for generating a virtual link(s) in an upper layer network on the basis of topology information of a lower layer network; and

a control means for, when at least one virtual link is included in a given path in the upper layer network, setting up a lower layer path corresponding to the virtual link to the lower layer network.

### Supplementary Note 2

The multi-layer network control device according to Supplementary note 1, wherein

the virtual link generation means generates the virtual link(s) by path calculation for between nodes in the lower layer network.

### Supplementary Note 3

The multi-layer network control device according to Supplementary note 2, wherein

the virtual link generation means registers metric information for the path calculation as additional information of the virtual link(s).

### Supplementary Note 4

The multi-layer network control device according to any one of Supplementary notes 1 to 3, wherein

the virtual link generation means generates the virtual link(s) so as to connect a plurality of nodes included in the upper layer network to each other in a desirable pattern(s).

### Supplementary Note 5

The multi-layer network control device according to any one of Supplementary notes 1 to 4, wherein

the given path is selected by a user request means on the basis of a virtual link(s) generated by the virtual link generation means.

### Supplementary Note 6

A multi-layer network control method that is a method to control a multi-layer network composed of a plurality of network layers, the method including:

generating a virtual link(s) in an upper layer network on the basis of topology information of a lower layer network by a virtual link generation means; and

setting up a lower layer path corresponding to the virtual link to the lower layer network by a control means, when at least one virtual link is included in a given path in the upper layer network.

### Supplementary Note 7

The multi-layer network control method according to Supplementary note 6, wherein

the virtual link generation means generates the virtual link(s) by path calculation for between nodes in the lower layer network.

### Supplementary Note 8

The multi-layer network control method according to Supplementary note 7, wherein

the virtual link generation means registers metric information for the path calculation as additional information of the virtual link(s).

### Supplementary Note 9

The multi-layer network control method according to any one of Supplementary notes 6 to 8, wherein

the virtual link generation means generates the virtual link(s) so as to connect a plurality of nodes included in the upper layer network to each other in a desirable pattern(s).

### Supplementary Note 10

The multi-layer network control method according to any one of Supplementary notes 6 to 9, wherein

the given path is selected by a user request means on the basis of a virtual link(s) generated by the virtual link generation means.

### Supplementary Note 11

A program that makes a computer function as a device to control a multi-layer network composed of a plurality of network layers, the program making the computer achieve:

a virtual link generation function to generate a virtual link(s) in an upper layer network on the basis of topology information of a lower layer network; and

a control function to, when at least one virtual link is included in a given path in the upper layer network, set a lower layer path corresponding to the virtual link to the lower layer network.

### Supplementary Note 12

The program according to Supplementary note 11, wherein

the virtual link generation function generates the virtual link(s) by path calculation for between nodes in the lower layer network.

### Supplementary Note 13

The program according to Supplementary note 12, wherein

the virtual link generation function registers metric information for the path calculation as an additional information of the virtual link(s).

### Supplementary Note 14

The program according to any one of Supplementary notes 11 to 13, wherein

the virtual link generation function generates the virtual link(s) so as to connect a plurality of nodes included in the upper layer network to each other in a desirable pattern(s).

### Supplementary Note 15

The program according to any one of Supplementary notes 11 to 14, wherein

the given path is selected by a user request means on the basis of a virtual link(s) generated by the virtual link generation means.

### Supplementary Note 16

A multi-layer control device that controls a multi-layer network in which a flow(s) set to a first layer network is/are used as a link(s) in a second layer network, including:

a user-facing network database that stores resource information available for a user;

a first layer network database that holds first layer network information;

a second layer network database that holds second layer network information;

a hierarchy control means for accessing the user-facing network database, the first layer network database, and the second layer network database to convert information of a flow(s) in the second layer network database to a link(s) in the user-facing network database and the second layer network database, and, on the basis of topology information in the first layer network database, creating a virtual link(s) corresponding to a flow(s) that has/have not been registered into the first layer network database in the user-facing network;

a first layer control means for, on the basis of a change(s) in flow information in the first layer network database, changing settings of respective nodes in the first layer network; and

a second layer control means for, on the basis of a change(s) in flow information in the second layer network database, changing settings of respective nodes in the second layer network.

### Supplementary Note 17

The multi-layer control device according to Supplementary note 16, wherein

the hierarchy control means, in creating the virtual link(s) in the user-facing network, performs path calculation for between nodes using information in the first layer network database, and, if the path calculation is successful, registers a calculated path(s) as a virtual link(s).

### Supplementary Note 18

The multi-layer control device according to Supplementary note 17, wherein

the hierarchy control means, in creating the virtual link(s) in the user-facing network, registers metric information for path calculation in the user-facing network as additional information of the virtual link(s) on the basis of information of a path(s) calculated using information in the first layer network database.

### Supplementary Note 19

A multi-layer control method to control a multi-layer network in which a flow(s) set to a first layer network is/are used as a link(s) in a second layer network, the method including:

a step of, in creating topology information in a user-facing network information database that is accessible by a user, creating virtual link information corresponding to flow information that has not been set in the first layer network to add the created virtual link information to the user-facing network information database;

a step of, when a flow is added to flow information in the user-facing network information database, deciding whether or not the added flow passes through a virtual link(s);

a step of setting up a flow(s) corresponding to the virtual link(s) that the flow passes through to the first layer network;

a step of changing the virtual link(s) corresponding to the flow(s) set to the first layer network to an already-set usual link(s); and

a step of, after changing all of the virtual link(s) that the added flow passes through to already-set usual link(s), setting up the added flow to the second layer network.

### Supplementary Note 20

A program that makes a computer function as a device to control a multi-layer network in which a flow(s) set to a first layer network is/are used as a link(s) in a second layer network, the program making the computer perform steps including:

a step of, in creating topology information in a user-facing network information database that is accessible by a user, creating virtual link information corresponding to flow information that has not been set in the first layer network to add the created virtual link information to the user-facing network information database;

a step of, when a flow is added to flow information in the user-facing network information database, deciding whether or not the added flow passes through a virtual link(s);

a step of setting up a flow(s) corresponding to the virtual link(s) that the flow passes through to the first layer network;

a step of changing the virtual link(s) corresponding to the flow(s) set to the first layer network to an already-set usual link(s); and

a step of, after changing all of the virtual link(s) that the added flow passes through to already-set usual link(s), setting up the added flow to the second layer network.

### INDUSTRIAL APPLICABILITY

The present invention can be applied to a service in which, for example, a carrier provides a user with a virtual network rapidly on demand. Specifically, the present invention is applicable to a VPN service that connects local networks of a user to one another, a network control portion of a cloud service that connects a data center to a user location or data centers to one another, or the like.

### REFERENCE SIGNS LIST

10 Multi-layer control device
20 User request unit
31 Lower layer network
32 Upper layer network
33 First layer network
34 Second layer network
35 Third layer network
40 Layer boundary
50 Multi-layer control device
101 User-facing network database
102 Upper layer network database
103 Lower layer network database
104 Hierarchy control unit
105 Upper layer control unit
106 Lower layer control unit
201 Management unit
202 External database access unit
203 Virtual network information creation unit
204 Layer boundary information management unit
205 Inter-database information correspondence management unit
206 Path calculation/management unit
5101 First hierarchy control unit
5102 Second hierarchy control unit
5201 First user-facing network database
5202 Second user-facing network database
5301 First layer network database
5302 Second layer network database
5303 Third layer network database
5401 First layer control unit
5402 Second layer control unit
5403 Third layer control unit
L001, L002 Upper layer link
L601 to L603 Lower layer link
L901 to L903 Virtual link
F701 Requested flow
F702 Upper layer flow
F703, F704 Set flow in lower layer

What is claimed is:

1. A multi-layer network control device that is a device to control a multi-layer network composed of a plurality of network layers, comprising:
a virtual link generation means for generating a virtual link in an upper layer network on the basis of topology information of a lower layer network; and
a control means for, when at least one virtual link is included in a given path in the upper layer network, setting up a lower layer path corresponding to the virtual link to the lower layer network.

2. The multi-layer network control device according to claim 1, wherein
the virtual link generation means generates the virtual link by path calculation for between nodes in the lower layer network.

3. The multi-layer network control device according to claim 2, wherein
the virtual link generation means registers metric information for the path calculation as additional information of the virtual link.

4. The multi-layer network control device according to claim 1, wherein
the virtual link generation means generates the virtual link so as to connect a plurality of nodes included in the upper layer network to each other in a desirable pattern.

5. The multi-layer network control device according to claim 1, wherein
the given path is selected by a user request means on the basis of a virtual link generated by the virtual link generation means.

6. A multi-layer network control method that is a method to control a multi-layer network composed of a plurality of network layers, the method comprising:
generating a virtual link in an upper layer network on the basis of topology information of a lower layer network by a virtual link generation means; and
setting up a lower layer path corresponding to the virtual link to the lower layer network by a control means, when at least one virtual link is included in a given path in the upper layer network.

7. The multi-layer network control method according to claim 6, wherein
the virtual link generation means generates the virtual link by path calculation for between nodes in the lower layer network.

8. The multi-layer network control method according to claim 7, wherein
the virtual link generation means registers metric information for the path calculation as additional information of the virtual link.

9. The multi-layer network control method according to claim 6, wherein
the given path is selected by a user request means on the basis of a virtual link generated by the virtual link generation means.

10. A non-transitory computer readable medium storing a program that makes a computer function as a device to control a multi-layer network composed of a plurality of network layers, the program making the computer achieve:
a virtual link generation function to generate a virtual link in an upper layer network on the basis of topology information of a lower layer network; and
a control function to, when at least one virtual link is included in a given path in the upper layer network, set up a lower layer path corresponding to the virtual link to the lower layer network.

11. The multi-layer network control method according to claim 6, wherein
the given path is selected by a user request means on the basis of a virtual links generated by the virtual link generation means.

12. The computer readable medium according to claim 10, wherein
the virtual link generation function generates the virtual link by path calculation for between nodes in the lower layer network.

13. The computer readable medium according to claim 12, wherein
the virtual link generation function registers metric information for the path calculation as an additional information of the virtual link.

14. The computer readable medium according to claim 10, wherein
the virtual link generation function generates the virtual link so as to connect a plurality of nodes included in the upper layer network to each other in a desirable pattern.

15. The computer readable medium according to claim 10, wherein
the given path is selected by a user request means on the basis of a virtual link generated by the virtual link generation means.
